(19) United States
(12) Patent Application Publication
(10) Pub. No.: US 2003/0236842 A1
(43) Pub. Date: Dec. 25, 2003

(54) E-mail address system and method for use between disparate client/server environments

(76) Inventors: Krishnamurti Natarajan, Hyderabad, IN (US); Hemchand Alla, Hyderabad, IN (US)

Correspondence Address: LEE & HAYES PLLC, 421 W RIVERSIDE AVENUE SUITE 500, SPOKANE, WA, 99201

(21) Appl. No.: 10/177,069

(22) Filed: Jun. 21, 2002

(51) Int. Cl. G06F 15/16

(52) U.S. Cl. 709/206; 709/245

(57) ABSTRACT

A client device accesses an on-line version of an address book when the client device is connected to a server and alternatively accesses an off-line version of the address book in lieu of the on-line version of the address book when the client device is not connected to the server. The on-line version of the address book and the off-line version of the address book are stored in disparate formats. The client device is able to seamlessly switch from the on-line version to the offline version, and vice versa, by monitoring whether the client is connected to the server.

### TECHNICAL FIELD

This invention relates to electronic mail (e-mail) application software, and more particularly, to address book features of the e-mail application software for use between disparate client/server environments.

### BACKGROUND

Address books are components of e-mail application programs. The address book serves as a contact information manager similar to a paper or desktop address book but with messaging and communication features. Address books are primarily used to store contact information about individuals and entities. Most are fully searchable, providing users with the ability to quickly find a specific contact or view a subset of information associated with an individual or entity. Address books can generally be accessed by a client through any type of online network connection to a server.

With the ever increasing popularity of portable client devices (such as laptops, personal digital assistants, cell phones and other related devices) it is also desirable to be able to view a latest version of the on-line address book, offline, when the client device isn't connected to a server. Viewing an address book offline provides the user with the ability to be able to look-up contact information stored locally within the client device. Assuming the client device uses an e-mail application software program that is compatible with a server device then it is likely that the client device can store the address book in the same format in which the address book is stored on the server. Accordingly, the client is able to download the address book from the server in the same data storage format received by the server.

For example, Microsoft® Outlook® messaging software is an e-mail application program designed to function interchangeably with a Microsoft® Exchange server. It is possible to download portions or an entire version of an on-line address book from the Microsoft® Exchange server to a client device using Microsoft® Outlook® messaging software, since the Microsoft® Exchange server and Microsoft® Outlook® messaging software store the address book in the same format. That is, the Microsoft® Outlook® messaging software is able to retrieve address information from the Microsoft® Exchange server, in a format that the Microsoft® Outlook® messaging software operating on the client, can store, and at a later time, read back and understand. Typically, the format used to store address information is hierarchical: meaning information is distributed among folders and subfolders.

There is a dilemma, however, when a client and server use disparate storage formats for maintaining the address book. In such situations it is not currently feasible to provide an address book that works seamlessly on-line as well as offline between the client and server, because the storage mediums for the two are different. That is the server provides information related to the address book that is stored in a format not readily stored nor understood (readable) by the client.

Take for example, Microsoft® Outlook® messaging software operating on a client device that connects to an on-line address book maintained on a Domino/Lotus Notes sever from IBM®. Outlook® messaging software is unable retrieve information (in the form of records) from the Domino/Lotus Notes database and store the records in the format they are received, because they are not in a format that the client can store, and at a later time, read back and understand. The records when received appear to be in a format that is flat (i.e., all the address information appears to be stored in a flat database with only a single folder as opposed to a hierarchical format as described above). Thus, this example illustrates the lack of flexibilities associated with open deployment of clients and servers running e-mail application software.

### SUMMARY

An e-mail address book for use with client/servers having disparate storage formats is described. In one implementation, a client device accesses an on-line version of the address book when the client device is connected to a server and alternatively accesses an off-line version of the address book in lieu of the on-line version of the address book when the client device is not connected to the server. The on-line version of the address book and the off-line version of the address book are stored in disparate formats.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 shows functional components of an example electronic mail (e-mail) system.

FIG. 2 is diagram illustrating the hierarchical arrangement of how an e-mail application program can store MAPI information using folders and subfolders.

FIG. 3 shows an address received from a server in the form of record which is stored as part of an e-mail message.

FIG. 4 is a flow chart illustrating a process for downloading addresses from server database for offline use on a client.

FIG. 5 illustrates the principal user interface associated with automatic resolving of a name or address entered in a field.

FIG. 6 is a flow chart illustrating a process for accessing information from a client database after a user performs an operation using a client side e-mail application program.

FIG. 7 illustrates an example of a computing environment within which the computer, network, and system architectures described herein can be either fully or partially implemented.

### DETAILED DESCRIPTION

The following discussion is directed to systems and methods for providing e-mail address book that operates on-line as well as offline between client and servers having disparate storage formats. The subject matter is described with specificity to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Example System Architecture

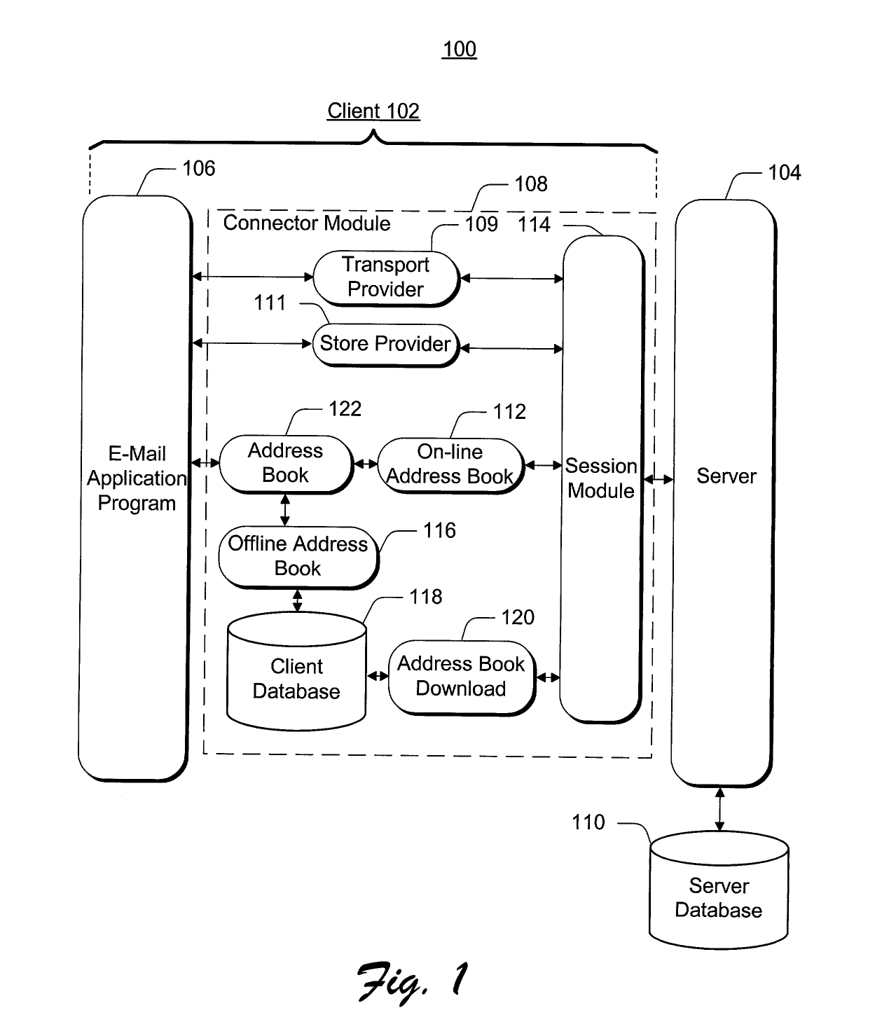

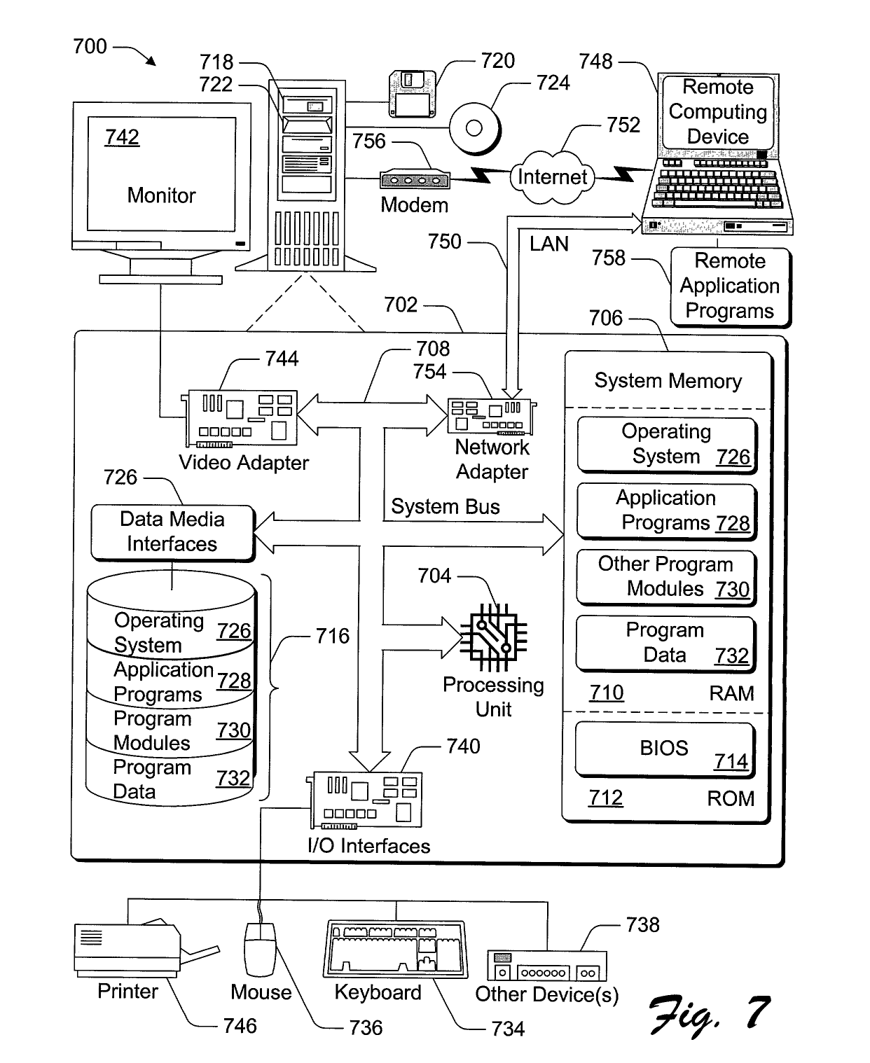

FIG. 1 shows functional components of an example electronic mail (e-mail) system 100. The exemplary implementations are directed to features associated with the e-mail system 100. E-mail system 100 includes a client side and server side. The client side includes a client 102 which is any type of computer device (see, e.g., FIG. 7) that utilizes a processor and has the capability of operating an e-mail application program. Examples of such devices include, but are not necessarily limited to: personal computers, portable computers, work stations, personal digital assistants, mobile communication platforms and other related computing devices.

Contained within the client 102 is an e-mail application program 106 that interacts with both client side and server side components. In one exemplary implementation, the e-mail application program 106 is represented by the Microsoft® Outlook® messaging software, which is a workgroup personal information management program produced by Microsoft Corporation of Redmond, Wash., USA. Briefly described, the program allows users to manage their own calendar, messages, tasks, notes and contacts and to share this information with others. Like many personal information managers, this program 106 is divided into several modules, including a calendar manager, a task list manager, an address book manager, a message manager (e-mail) and a notes manager. Of particular interest to this description is the address book component(s) of e-mail system 100 with respect to a connector 108, to be described in more detail.

The server side includes a server 104 as well as a server database 110. The server 104 represents a class of servers capable of servicing clients. In one exemplary implementation, the server 104 is represented by the IBM® Lotus Notes/Domino server system, which is a server system produced by International Business Machines Corporation of Armonk, N.Y., USA. Although the exemplary implementations will generally be described in the context of these client and server side representations (Outlook® and Domino), it is possible that other client side and server side platforms could be used in accordance with the principles and illustrations described herein.

In the exemplary implementations, the client 102 and server 104, store and manipulate data associated with the e-mail application program 106 in different formats. For instance, Microsoft® Outlook® messaging software is designed to operate seamlessly with Microsoft's Exchange® servers, which interprets and stores e-mail data in the same format whether on the client side or server side.

To ensure that there is interoperability between Microsoft® Outlook® messaging software on client 102 and Lotus Notes on the IBM® Domino server, a connector module 108 is used to integrate messaging interoperability and connectivity between them. Module 108 includes Messaging Application Programming Interface (MAPI) modules that enable messages and data to be sent from the client 102 to server 104, and vice versa.

A transport provider module 109 is responsible for sending messages to and receiving messages from connector module 108. The transport provider 109 performs several functions related to messaging distribution. These include, for instance, informing the e-mail application program 106 when a new message has been received from server 104, and invoking message preprocessing and post-processing. The transport provider 109 also handles message transmission and reception between the client 102 and server 104.

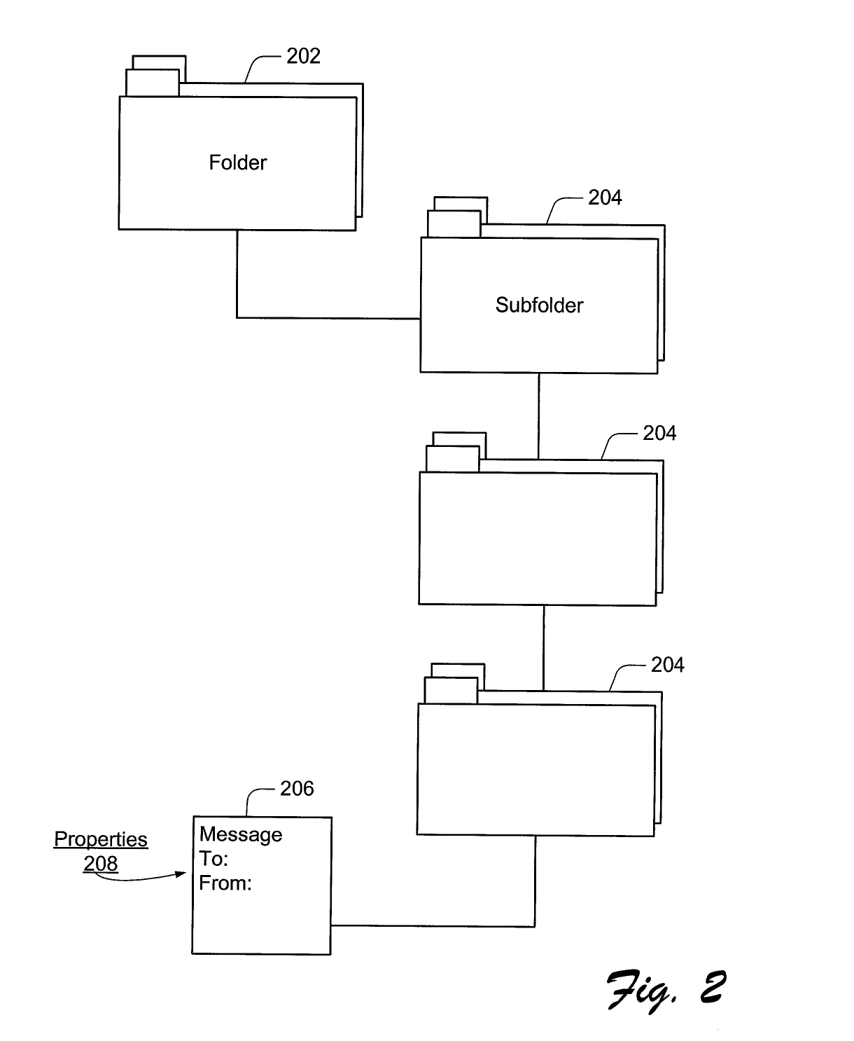

The store provider module 111 handles the storage and retrieval of messages and other information for application program 106 as well as application modules such as address book module 122. Information stored by e-mail application program 106 is stored and organized using a hierarchical system, which is implemented in multiple levels, with containers called folders holding messages of different types. There is no limit to the number of levels provided by store provider 111. FIG. 2 is diagram illustrating the hierarchical arrangement of how application program 106 may store MAPI information using folders 202 and subfolders 204. Store provider 111 allows each application to access information stored in each of the folder(s) 202 or subfolder(s) 204.

Address book module 122 handles access to directory and contact information. Depending on the type of recipient and address book module 122, there is a wide range of contents in the form of address properties that can be made available. For example, address book module 122 may access a recipient's name, postal address, e-mail address, distribution list, personal address book, etc. The contents of address book module 122 can either be obtained from an on-line address book module 112 when client 102 is in session with server 104. The on-line address book module 112 accesses requested contents for address book module 122 from database 110 vis-a-vis server 104.

Alternatively, in lieu of accessing the on-line address book module 112, address book module 122 can access an offline address book module 116, when the client 102 is not in session with the server 104. The offline address book module 116 retrieves address book contents from a local database: client database 118. The offline-address-book-download module 120 retrieves information pertaining to the on-line address book from server database 110 while there is an active session (on-line) with server 104. The offline-address-book-download module 120 can be instructed to perform a complete download of the address book contents or an incremental download. In response to a user initiated action or request, the download is performed in the background when client 102 is in session with server 104. The incremental download retrieves all the addresses and/or properties that were added, deleted or modified since any prior downloads.

The session module 114 monitors when there is an active and on-line session between the client 102 and server 104. If the session module 114 detects that an on-line connection is lost, then the address book module 112 switches from retrieving addresses (contents for the address book module 122) from the on-line address book module 112 to the offline address book module 116. When offline, addresses are retrieved from the client database 118 instead of the server database 110. Alternatively, if the session module 114 detects that an on-line connection is reestablished (or established) between the client 102 and server 104, the address book module 122 switches from the offline address book module 116 to the on-line address book module 112. Accordingly, when in session, addresses for address book module 122 are ultimately retrieved from server database 110 via on-line address book module 112.

All information stored in client database 118 is stored in a MAPI data store. Client database 118 arranges all its records as MAPI folders and MAPI messages. Each folder 202 can contain subfolders 204 or one or more messages 206. Messages are units of data transferred from one user to another such as an e-mail message. In the MAPI store, messages (objects) are composed of properties. In most cases, fields, (such as “To,” “From,” “Subject”) map directly to a MAPI property 208. Additionally, folders 202, subfolders 204 and messages 206 have certain properties 208 describing them, for example, PR_ENTRYD contains a unique identifier to a message 206 or folder 202. PR_DISPLAY_NAME property stores the name of the folders and messages. The database 118 permits interfaces, IMAPIFolder and IMessage interfaces, to store and retrieve data from the database 118.

Downloading the Address Book

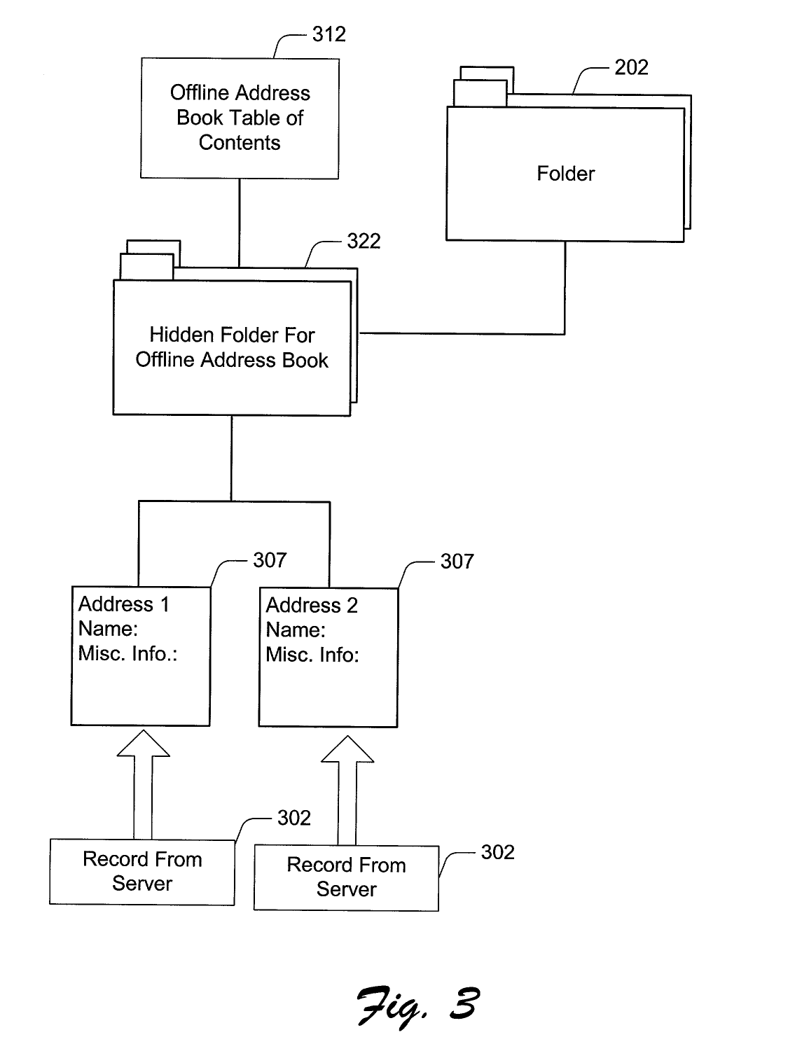

As described above, the address-book-download module 120 is responsible for downloading addresses from server database 110 to the client database 118. Accordingly, in the exemplary implementation, address-book-download module 120 creates a “hidden folder” 322 to be described with reference to FIG. 3 below) in client database 118 and assigns a unique identifier to the folder. To compensate for the dissimilarity between the storage formats of the Lotus Notes/Domino Server 104 and the client 102, addresses that are received as individual records from the server database 110 are embedded (stored in messages). As used herein, a “record” means a collection of fields. A “message” in the MAPI environment, is a collection of properties. Accordingly, each field retrieved from the record on server 104 is stored as a property in the message, which is created for each corresponding address record retrieved from server 104.

FIG. 3 shows how records 302 received from server 104 are stored in a format compatible with e-mail application program 106. In this example, the record 302 (containing address information) is stored in a message 307, which in turn is stored in the hidden folder 322. Each address (e.g., address 1, address 2) is stored within an individual message 307. The hidden folder 322 can serve as the offline address book 116, when connector module 108 is not in session with server 104. To ensure that messages stored in the hidden folder 322 are differentiated from messages that are native to the client 102, the hidden folder 322 is not readily viewable by a user: thus referred to as “hidden.”

Thus, connector module 108 enables addresses received in a flat format to be stored in client database 118 in a hierarchical fashion. By embedding the addresses in e-mail messages 307 and storing the messages 307 in a folder 322 or within client database 118, connector module 108 enables email application program 106 to interface with a server 104.

Lists of addresses (e.g., address 1, address 2, etc.) can be displayed by opening an offline address book table of contents 312. The offline address book table of contents 312 can be stored in folder 202 or in its own subfolder 204. In this example, all addresses are maintained in a single folder (hidden folder 322).

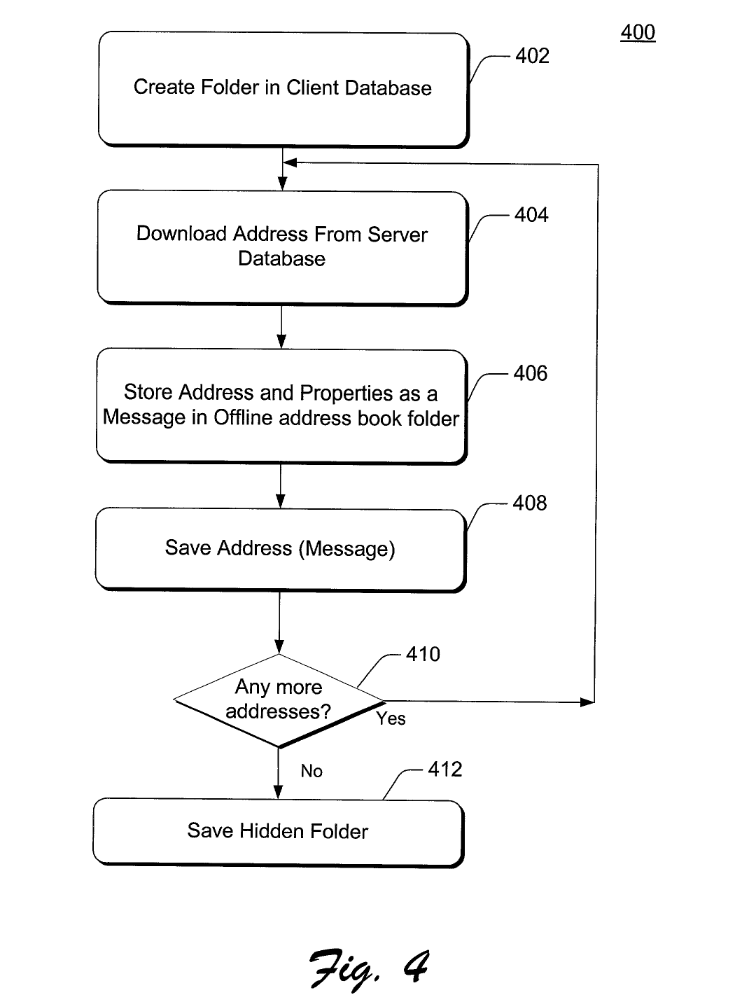

FIG. 4 is a flow chart illustrating a process 400 for retreiving addresses from server database 110 for offline use on client 102. Process 400 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in software (such as in the form of modules or programs) running on client 102.

At a block 402, at least one folder 202 is created for which the offline address book module 116 can open when the session module 114 indicates that the client 102 is not in session with the server 104. The folder 202 is stored in client database 118.

At a block 404, at least one address is retrieved from the server database 110 by the address book download module 120. While downloading addresses for the address book module 122, the user can select a complete download or an incremental download. Again, the incremental download retrieves the addresses that were either added, deleted or modified since the last download was performed

At a block 406, address(es) and properties from a record 302 are stored as a message 307 in hidden folder 322 (also referred to as the offline address book folder). At a block 408, the e-mail message is stored for later retrieval by the offline address book module 116 when client 202 is not in session with server 104.

At block 410, a determination is made whether any more addresses need to be stored in the client database 118. If according to the “Yes” branch of block 410, more addresses need to be retrieved and processed, then blocks 404-408 are repeated until all the new addresses are saved as described in process 400. If according to the “No” branch of block 410, the process of retrieving and saving address is complete, then at a block 412 the hidden folder 322 is saved in database 118.

Resolving a String to an Address

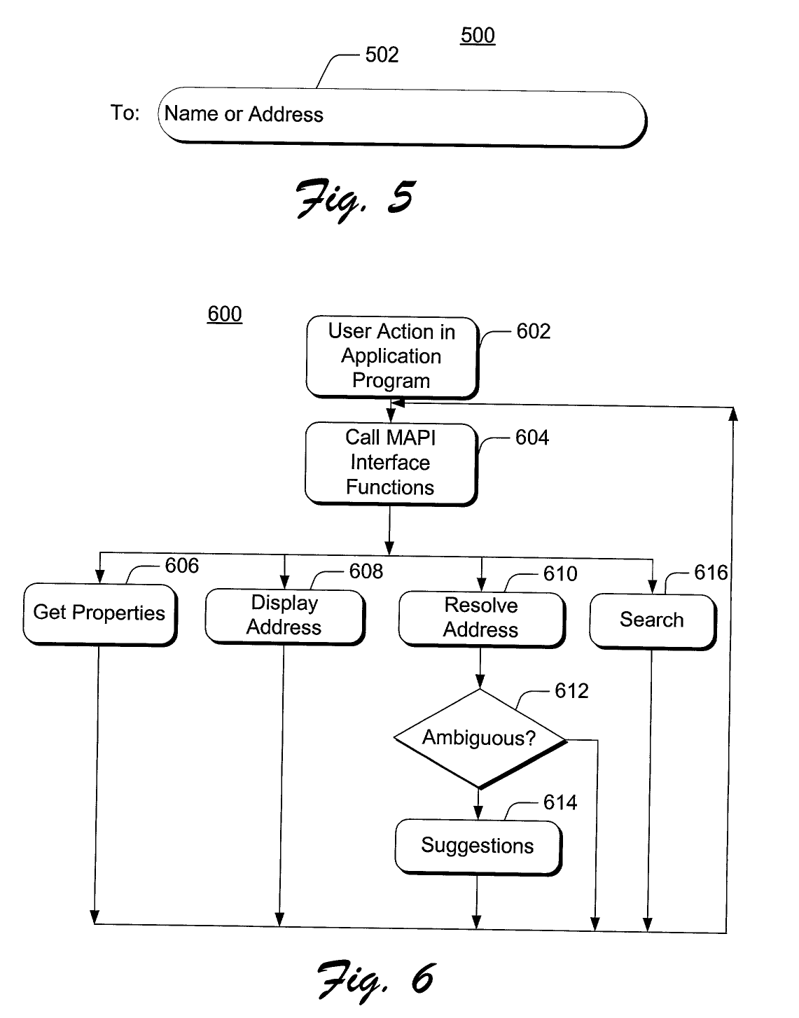

When an e-mail user composes an e-mail message, the user identifies the recipient(s) of the message by entering one or more names in the message's address field. FIG. 5 illustrates a user interface 500 employed for the message's address field 502. Before the message can actually be transmitted by the e-mail application program 106, the program 106 matches each display name or address entered in the address field 502 to specific addresses associated with the address book module 122. The process of matching the displayed name(s) or address(es) to an address from the address book module 122 is referred to resolving a string to an address. This process of resolving the string is usually performed in the background while the user is composing the name or address in the address field 502.

In the exemplary implementation, the following properties are searched to resolve a string passed onto the address book module 122: (1) full name, (2) last name, (3) e-mail address, and (4) nick name/alias. Before resolving a name the address book is first short listed by collecting all the addresses which contain a string to resolve one of the four enumerated properties and stored in a table within database 118. All further searches are conducted on the table within database 118. For each of the enumerated properties, the table is first sorted based on that particular property in ascending order. Then that property is compared to the string to be to obtain an exact match. The search continues until an exact match is found on either nick name, e-mail address, or last name. In case, there isn't an exact match using the above three properties, the full name is searched in a similar way except that even partial matches are considered. A string is considered “resolved” when an exact match is found on any of the four enumerated properties or if there is only one partial hit while searching for a full name. If there is more than one address then the string is ambiguous. In the event there ambiguity, the e-mail application program 106 indicates that the displayed name or address needs to be manually matched and possibly offer similar found names underneath the field 502.

Address Book Retrieval of Information

FIG. 6 is a flow chart illustrating a process 600 for the address book module 122 to access information from the client database 118 after a user performs an operation using e-mail application program 106. Process 600 includes various operations illustrated as blocks. The order in which the process is described is not intended to be construed as a limitation. Furthermore, the process can be implemented in any suitable hardware, software, firmware, or combination thereof. In the exemplary implementation, the majority of operations are performed in software (such as in the form of modules or programs) running on client 102.

At a block 602, a user performs an action associated with using the e-mail application program 106. For example, the action may include sending and retrieving e-mail messages, displaying addresses, obtaining properties associated with an address, and many other actions associated with the e-mail application program. At a block 604, depending on the user action, Email Application Program 106 calls MAPI interface functions of the Address Book.

For instance, at a block 606, when the properties of an address are to be retrieved the MAPI interface functions are called with an EntryID property (a property tag) which uniquely identifies a user or a distribution list. Accordingly, the offline address book table of contents 312 is searched and if there is a match, then a query is made of to retrieve the properties of that user or distribution list.

At a block 608, the Email Application 106 retrieves addresses from the offline address book table of contents 312 by calling IMAPITable interface functions.

At blocks 610, 612 and 614, the MAPI interface functions resolve a string to an address as described with reference to the preceding section.

Finally, at a block 616, the MAPI interface functions of the address book module 122 search the address book for a particular query initiated by the user similar to the search performed when resolving an address. The search is initially restricted to the offline address book table of contents 312.

Exemplary Computing System and Environment

FIG. 7 illustrates an example of a computing environment 700 within which the computer, network, and system architectures (such as e-mail system 100) described herein can be either fully or partially implemented. Exemplary computing environment 700 is only one example of a computing system and is not intended to suggest any limitation as to the scope of use or functionality of the network architectures. Neither should the computing environment 700 be interpreted as having any dependency or requirement relating to any one or combination of components illustrated in the exemplary computing environment 700.

The computer and network architectures can be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, gaming consoles, distributed computing environments that include any of the above systems or devices, and the like.

Connector module 108 may be described in the general context of computer-executable instructions, such as program modules, being executed by a computer. Generally, program modules include routines, programs, objects, components, data structures, etc. that perform particular tasks or implement particular abstract data types.

The computing environment 700 includes a general-purpose computing system in the form of a computer 702. The components of computer 702 can include, by are not limited to, one or more processors or processing units 704, a system memory 706, and a system bus 708 that couples various system components including the processor 704 to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer system 702 typically includes a variety of computer readable media. Such media can be any available media that is accessible by computer 702 and includes both volatile and non-volatile media, removable and non-removable media. The system memory 706 includes computer readable media in the form of volatile memory, such as random access memory (RAM) 710, and/or non-volatile 19 memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 can also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternatively, the hard disk drive 716, magnetic disk drive 518, and optical disk drive 722 can be connected to the system bus 708 by a SCSI interface (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 716, magnetic disk 720, optical disk 724, ROM 712, and/or RAM 710, including by way of example, an operating system 526, one or more application programs 728, other program modules 730, and program data 732. Each of such operating system 726, one or more application programs 728, other program modules 730, and program data 732 (or some combination thereof) may include an embodiment of connector module 108 in conjunction with e-mail application program 106.

Computer system 702 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746 which can be connected to computer 702 via the input/output interfaces 740.

Computer 702 can operate in a networked environment using logical connections to one or more remote computers, such as a remote computing device 748. By way of example, the remote computing device 748 can be a personal computer, portable computer, a server, a router, a network computer, a peer device or other common network node, and the like. The remote computing device 748 is illustrated as a portable computer that can include many or all of the elements and features described herein relative to computer system 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet. When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components, such as the operating system, are illustrated herein as discrete blocks, although it is recognized that such programs and components reside at various times in different storage components of the computer system 702, and are executed by the data processor(s) of the computer.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for operating a client device, comprising: accessing an on-line version of an address book when the client device is connected to a server; and alternatively accessing an off-line version of the address book in lieu of the on-line version of the address book when the client device is not connected to the server; wherein the on-line version of the address book and the off-line version of the address book are stored in disparate formats.

2. The method as recited in claim 1, wherein the method is performed by a processor of the client device.

3. The method as recited in claim 1, wherein the on-line address book is stored in a Domino Notes server database.

4. The method as recited in claim 1, wherein the off-line address book is stored in a database resident with the client device that uses Microsoft® Outlook® messaging software..

5. The method as recited in claim 1, wherein a session module operating on the client device selects between the accessing the on-line address book and the alternatively accessing the offline address book.

6. A method for operating a client device, comprising:
receiving an address from a server;
storing the address in a message associated with an e-mail application; and
storing the message in an offline address book folder that can be accessed by the client device when not in session with the server.

7. The method as recited in claim 6, wherein the client device and server store address properties in disparate storage formats.

8. The method as recited in claim 6, wherein the offline address book folder is hidden.

9. The method as recited in claim 6, wherein the offline address book folder is a MAPI folder that contains subfolders and/or other e-mail messages containing address properties.

10. The method as recited in claim 6, wherein the address is stored as a MAPI message inside the offline address book folder.

11. The method as recited in claim 6, wherein the server is a Lotus Domino/Notes type server.

12. The method as recited in claim 6, wherein the client device is a computer device that uses Microsoft® Outlook® application software, running on one or more processors in the computer device, to create the e-mail message.

13. One or more computer-readable media comprising computer-executable instructions that, when executed, perform the method as recited in claim 6.

14. A method for operating a client device, comprising:
downloading an address book from a server, the address book containing a plurality of addresses;
creating at least one folder in a database to store the address book when downloaded from the server, the at least one folder accessible by the client device when not in session with the server;
storing the plurality of addresses in a plurality of messages, respectively; and
storing the messages in the at least one folder in the database.

15. The method as recited in claim 14, further comprising creating a list of the messages and using the list to construct a table of contents for the address book.

16. The method as recited in claim 14, further comprising periodically updating the address book after the address book is downloaded from the server by periodically retrieving addresses that were added, deleted and/or modified since a previous downloading of the address book from the server.

17. The method as recited in claim 14, further comprising resolving a string received by the client device by searching the database for a property that matches the string by using one of the following categories indicated by the string to shorten the search of the database: last name, e-mail name and/or nickname/alias.

18. The method as recited in claim 14, wherein the server is a Lotus Domino/Notes type server.

19. The method as recited in claim 14, wherein the client device is a computer device that uses Microsoft® Outlook® application software, running on one or more processors in the computer device, to create the e-mail message.

20. One or more computer-readable media comprising computer-executable instructions that, when executed, perform the method as recited in claim 14.

21. A client device comprising: a connector operable in a selectable one of: an on-line address book in which the connector receives e-mail address information from a server database; and an offline address book in which the connector receives e-mail address information from a local database, within the client device, in lieu of the on-line address book mode, wherein the on-line version of the address book and the off-line version of the address book are stored in disparate formats.

22. The client device as recited in claim 21 wherein the connector is a software interface module configured to operate on a processor of the client device.

23. The client device as recited in claim 21 wherein the e-mail address information associated with offline address book is stored in e-mail messages.

24. The client device as recited in claim 21 wherein e-mail address information is stored in a Domino server database.

25. The client device as recited in claim 21 wherein a session module operating on the client device selects between the on-line address book and offline address book when the session module detects that the client device is connected or disconnected, respectively, from the server.

26. One or more computer-readable media having stored thereon computer executable instructions that, when executed by one or more processors, causes the one or more processors of a computer system to:
receive an address from a server;
store the address in a message associated with an e-mail application; and
store the message in an offline address book folder that can be accessed by the computer system when not in session with the server.

27. One or more computer-readable media as recited in claim 26, wherein the computer system and server store address properties in disparate storage formats.

28. One or more computer-readable media as recited in claim 26, further comprising computer executable instructions that, when executed, direct the computer system to assign an identification name to the folder.

29. One or more computer-readable media as recited in claim 26, wherein the folder is a MAPI folder that contains subfolders and/or other e-mail messages containing address properties.

30. One or more computer-readable media as recited in claim 26, wherein the e-mail message is a MAPI message.

31. One or more computer-readable media as recited in claim 26, wherein the server is a Lotus Domino/Notes type server.

32. One or more computer-readable media as recited in claim 26, wherein the client device is a computer device that uses Microsoft® Outlook® application software, running on one or more processors in the computer device, to create the e-mail message.

33. One or more computer-readable media having stored thereon computer executable instructions that, when executed by one or more processors, causes the one or more processors of a computer system to:
download an address book from a server, the address book containing a plurality of addresses;
create at least one folder in a database to store the address book when downloaded from the server, the at least one folder accessible by the client device when not in session with the server;
store the plurality of addresses in a plurality of email messages, respectively; and
store the e-mail messages in the at least one folder in the database.

34. One or more computer-readable media as recited in claim 33, further comprising computer executable instructions that, when executed, direct the computer system to create a list of the email messages and utilize the list to construct a table of contents for the address book.

35. One or more computer-readable media as recited in claim 33, further comprising computer executable instructions that, when executed, direct the computer system to periodically update the address book after the address book is downloaded from the server by periodically retrieving addresses that were added, deleted and/or modified since a previous downloading of the address book from the server.

36. One or more computer-readable media as recited in claim 33, further comprising computer executable instructions that, when executed, direct the computer system to resolve a string received by the client device by searching the database for a property that matches the string by using one of the following categories indicated by the string to shorten the search of the database: last name, e-mail name and/or nickname/alias.

37. One or more computer-readable media as recited in claim 33, wherein the server is a Lotus Domino/Notes type server.

38. One or more computer-readable media as recited in claim 33, wherein the client device is a computer device that uses Microsoft® Outlook® application software, running on one or more processors in the computer device, to create the e-mail message.

39. A system for operating a client device, comprising: means for accessing an on-line version of an address book when the client device is connected to a server; and alternatively means for accessing an off-line version of the address book in lieu of the on-line version of the address book when the client device is not connected to the server; wherein the on-line version of the address book and the off-line version of the address book are stored in disparate formats.

40. The system as recited in claim 39, wherein the on-line address book is stored in a flat database.

41. The system as recited in claim 39, wherein the off-line address book is stored in a hierarchical database residing within the client device.

42. The system as recited in claim 39, wherein a session module operating on the client device selects between the means for accessing the on-line address book and alternatively the means for accessing the offline address book.
